(19) United States
(12) Patent Application Publication
(10) Pub. No.: US 2021/0121804 A1
(43) Pub. Date: Apr. 29, 2021

(54) WASHABLE HVAC FILTER AND FILTER MEDIA

(71) Applicant: NxtNano, LLC, Lenexa, KS (US)

(72) Inventors: Alan Smithies, Overland Park, KS (US); Andrew Albert Lander McDowell, Bucyrus, KS (US); Dakota Hendrickson, Kansas City, MO (US)

(21) Appl. No.: 16/667,528

(22) Filed: Oct. 29, 2019

(51) Int. Cl. B01D 39/16; B01D 46/00; B01D 46/52; B32B 5/02; B32B 5/26

(52) U.S. Cl. CPC B01D 39/1623; B32B 2307/73; B01D 46/521; B32B 5/022; B32B 5/26; B01D 2239/0428; B01D 2239/0435; B01D 2239/0478; B01D 2239/0618; B01D 2239/0622; B01D 2239/0631; B01D 2239/065; B01D 2239/1258; B01D 2275/10; B01D 2279/50; B32B 2250/20; B32B 2250/246; B32B 2255/02; B32B 2262/0238; B32B 2262/0253; B32B 2307/724; B01D 46/0032

(57) ABSTRACT

The present invention generally relates to washable HVAC filter media. More particularly, the present invention generally relates to washable HVAC filter media comprising an electrospun nanofiber layer disposed between a nonwoven support layer and a pre-filter meltblown layer that may be electrostatically charged. Unlike existing HVAC filter media, the present filter media may be subjected to multiple washings and still maintain its filtration efficiency.

### BACKGROUND

### 1. Field of the Invention

The present invention generally relates to washable HVAC filter media. More particularly, the present invention generally relates to washable HVAC filter media comprising an electrospun nanofiber layer disposed between a pre-filter layer comprising meltblown fibers and a nonwoven layer.

### 2. Description of the Related Art

Generally, most heating, ventilation, air conditioning, and HVAC filters used in today's residential, commercial, or industrial applications are based on two distinct and antiquated filter media technologies: wet-laid micro-glass media and electrostatically charged synthetic media. However, both these filter media types have functional and performance limitations that prevent these media types from meeting both the current and new air pollution control regulations being enacted in many countries around the world. Moreover, these filter types are not cleanable or washable, which in turn renders them non-reusable and undesirable from an environmental or sustainability perspective.

More specifically, wet-laid micro-glass filter media is fundamentally a mechanical filter in that the basis weight, the pore structure, and the fiber sizes will dictate the initial filtration efficiency of the media and, under normal filtration principles, dust particles will be captured via interception and impaction during the application. Over time, the filter media becomes contaminated with dirt particles and the pressure drop across the filter increases until the filter reaches terminal life. Given that micro-glass media is essentially a paper, it cannot be washed or cleaned with water as it would simply disintegrate; therefore, wet-laid microglass filter media cannot be reused. Furthermore, it is well known that micro-glass filter media is not an environmentally friendly material and may cause health-related issues.

Alternately, the other common HVAC filter media on the market, electro-statically charged synthetic media, also exhibits serious limitations when it comes to washing and reuse. Generally, the electrostatically charged synthetic media may comprise a meltblown nonwoven with an inherent electrostatic charge that forms a static field around the fiber within the media. Typically, it is this electrostatic charge the helps capture the dust particles. This electrostatic charge is important because uncharged media usually possess a very large and open pore structure and, therefore, can constitute very poor filtration media. However, when the electrostatic charged is applied, these medias generally exhibit very good filtration efficiencies at very low operating pressure drops. The limitation of electrically charged media is a short filtration life due to the electrostatic charge becoming fully consumed with dust particles over time. Another drawback with electrostatically charged synthetic media is that it is usually fitted with a paper or paperboard frame; thus, the paperboard frame, along with the electrostatic charge of the media, will be damaged or lost if the media is washed or cleaned with water.

Finally, a new international test standard ISO 16890 was recently implemented in the HVAC global industry in 2018. This new standard certifies and qualifies the performance of an HVAC filter media by utilizing a test procedure that neutralizes the electrostatic charged filter media. More particularly, this new test standard involves pre-treating all filter medias by exposing them to isopropyl alcohol over a timed duration. Consequently, this basically eliminates the electrostatic charge and effective filtration properties of the charged media, before the filter media is even used.

Accordingly, there is a need for a washable HVAC filter media that may meet the new international test standards implemented in 2018.

### SUMMARY

One or more embodiments of the present invention generally concern a washable filter media. Generally, the filter media comprises: (a) a pre-filter layer comprising one or more meltblown fibers; (b) a nonwoven layer comprising one or more synthetic fibers; and (c) a nanofiber layer comprising one or more nanofibers, wherein the nanofiber layer is disposed between the pre-filter layer and the nonwoven layer. Furthermore, the filter media may exhibit an initial filtration efficiency rating of at least MERV 11 as measured according to the ASHRAE 52.2 test method.

One or more embodiments of the present invention generally concern a washable filter. Generally, the filter comprises: (a) a pre-filter layer comprising one or more meltblown fibers; (b) a nonwoven layer comprising one or more synthetic fibers; (c) a nanofiber layer comprising one or more nanofibers, wherein the nanofiber layer is disposed between the pre-filter layer and the nonwoven layer; (d) a first pleating support layer positioned proximately to the nonwoven layer; and (e) a second pleating support layer positioned proximately to the pre-filter layer. Furthermore, the filter media may exhibit an initial filtration efficiency rating of at least MERV 11 as measured according to the ASHRAE 52.2 test method.

One or more embodiments of the present invention generally concern a method of filtering a fluid stream. Generally, the method comprises: (a) providing a filter media and (b) passing the fluid stream through the filter media. The filter media generally comprises: (a) a pre-filter layer comprising one or more meltblown fibers; (b) a nonwoven layer comprising one or more synthetic fibers; and (c) a nanofiber layer comprising one or more nanofibers, wherein the nanofiber layer is disposed between the pre-filter layer and the nonwoven layer. Furthermore, the filter media may exhibit an initial filtration efficiency rating of at least MERV 11 as measured according to the ASHRAE 52.2 test method.

### BRIEF DESCRIPTION OF THE FIGURES

Embodiments of the present invention are described herein with reference to the following drawing figures, wherein:

FIG. 1 depicts an exemplary embodiment of a three-layered filter media;

FIG. 2 depicts an exemplary embodiment of a five-layered filter media;

FIG. 3 depicts an exemplary embodiment of a pleated version of the three-layered filter media;

FIG. 4 depicts an exemplary embodiment of a pleated version of the five-layered filter media;

FIG. 5 depicts an exemplary filter cartridge configuration comprising the layered filter media and a support layer;

FIG. 6 is a chart demonstrating the filtration efficiencies of the inventive filter media compared to a commercially-available filter media after multiple washings; and

FIG. 7 is a chart demonstrating the filtration efficiencies of the inventive filter compared to a commercially-available filter after multiple washings.

### DETAILED DESCRIPTION

As discussed below, the inventive filter media and filter addresses the deficiencies of existing HVAC filter media. More particularly, the present filter media utilizes new and innovative synthetic nanofiber materials to overcome the performance limitations of current filter media technology and, consequently, may provide a washable and reusable filter media that exhibits longer operating life, provides lower operating costs, and exhibits minimal functional filtration loss after multiple washings. Consequently, the inventive washable filter media and filters derived therefrom may provide an HVAC filter that is an environmentally friendly alternative to those that are presently being sold commercially, especially since the inventive filter media may be washed, cleaned, and reused after multiple washing cycles. Presently, current HVAC filters are generally discarded after a single use at an average of three months. In contrast, the inventive filter media may be washed and reused at least six or more times, which would require the filter to be changed only every 18 months or longer. Consequently, the cost savings to the consumer could be significant.

FIG. 1 depicts an exemplary embodiment of the inventive filter media. As shown in FIG. 1, the filter media 10 generally comprises a nanofiber layer 12 disposed between a pre-filter layer 14 and a nonwoven layer 16. As discussed below, and in various embodiments, the filter media 10 may comprise a polyester or polypropylene nonwoven layer 16 that is coated with an electrospun nanofiber layer 12, which can be made up of a plurality of nanofibers. Furthermore, in various embodiments, the filter media 10 may comprise a pre-filter nonwoven layer 14 comprising polyester and/or polypropylene meltblown fibers, which acts as a dust capturing layer and protects the inner nanofiber layer 12. Unlike present HVAC filter media, the filter media 10 may be produced from materials that can be washed and are not degraded during a water-based washing process.

When used in filtration application, the filter media 10 depicted in FIG. 1 comprises an upstream side and a downstream side. Generally, the pre-filter nonwoven layer 14 forms the upstream side and may be positioned against the dirty gas stream, while the nonwoven layer 16 may form the downstream side and be positioned away from the dirty gas stream inside the HVAC system. Furthermore, in various embodiments, the filter media 10 utilizes mechanical filtration due to its depth filtration construction. Moreover, all of the components used in the filter media 10 may comprise synthetic materials and, therefore, may be resistant to being changed when in contact with water or washed with water.

Typically the pre-filter nonwoven layer 14 may function as a surface filtration layer. In various embodiments, this pre-filter layer 14 can either be electrostatically charged or not. Typically, the physical properties of the pre-filter nonwoven layer 14 may largely influence the air permeability and density of the filter media 10 and largely determine the maximum dust holding capacity of the filter media 10. Ideally, the pre-filter nonwoven layer 14 filters out the larger particles from the dirty gas stream and only allows finer particulates to pass to the nanofiber layer 12.

Generally, the nanofiber layer 12 may largely influence the overall filtration efficiency performance of the filter media depicted in FIG. 1. In various embodiments, the nanofiber layer 12 may function as a fine filtration layer within the filter media 10 and may comprise a plurality of nanofibers having average diameters ranging from 10 to 750 nm, 25 to 500 nm, or 50 to 250 nm.

In various embodiments, the nanofibers are produced using electrospinning technology. Generally, any conventional electrospinning process known in the art may be used to produce the nanofibers. The nanofiber fiber size, nanofiber type, and quantity of nanofibers may vary depending upon the final filter rating that is desired.

In various embodiments, the nanofiber layer 12 can comprise at least 60, 65, 70, 75, 80, 85, 90, 95, or 99 weight percent of at least one nanofiber. In certain embodiments, the first nanofiber layer 12 can comprise, consist essentially of, or consist of at least one nanofiber. In one or more embodiments, the nanofibers may comprise an average diameter of at least 1, 5, 10, 20, 30, 40, or 50 nm and/or less than 750, 500, 400, 350, 300, or 250 nm.

In various embodiments, the nanofiber layer 12 can comprise a basis weight of at least 0.01, 0.05, 0.1, 0.2, 0.5, or 1.0 gsm and/or less than 5.0, 4.0, 3.0, or 2.0 gsm as measured according to ASTM D461.

The nanofibers forming the nanofiber layer 12 can be made from various types of thermoplastic polymers such as, for example, polyarylsulfone, fluoropolymers, thermoplastic elastomers, and/or other organic (co)polymer resins. More specific examples of the polymers can include thermoplastic polyurethane (TPU), polyvinylidene fluoride (PVDF), polyethersulfone (PESU), and/or polyacrylonitrile (PAN). In certain embodiments, thermoplastic polyurethane (TPU) or polyvinylidene fluoride (PVDF) are used to produce the nanofibers.

Turning to the pre-filter meltblown layer 14, the pre-filter meltblown layer 14 may comprise, consist essentially of, or consist of one or more meltblown fibers. In various embodiments, the pre-filter layer 14 may comprise at least 60, 65, 70, 75, 80, 85, 90, 95, or 99 weight percent of one or more meltblown fibers. These meltblown fibers may comprise polyester fibers, polypropylene fibers, or combinations thereof.

Furthermore, in various embodiments, the pre-filter layer 14 may be electrostatically charged. Alternatively, in various embodiments, the pre-filter layer 14 may not be electrostatically charged.

In various embodiments, the pre-filter layer 14 comprises a basis weight of at least 5, 10, 15, 20 gsm and/or less than 120, 110, 100, 90, 80, 75, 70, 65, 60, 55, 50, 45, or 40 gsm as measured according to ASTM D461.

Turning to the nonwoven layer 16, the nonwoven layer 16 may comprise, consist essentially of, or consist of one or more synthetic fibers. In various embodiments, the nonwoven layer 16 may comprise at least 60, 65, 70, 75, 80, 85, 90, 95, or 99 weight percent of one or more synthetic fibers. These synthetic fibers may comprise polyester fibers, polypropylene fibers, or combinations thereof.

Furthermore, in various embodiments, the nonwoven layer 16 may comprise an air-laid, spunbond, or wet-laid nonwoven.

In various embodiments, the nonwoven layer 16 comprises a basis weight of at least 5, 10, 15, 20 gsm and/or less than 120, 110, 100, 90, 80, 75, 70, 65, 60, 55, 50, 45, or 40 gsm as measured according to ASTM D461. Alternatively, in various embodiments, the basis weight of the nonwoven layer 16 may be selected so as to provide a layer that can form and support pleats in the filter media. A heavier basis weight allows the nonwoven layer 16 to be more durable and may allow the formation of pleated filter media without the need for the co-pleat layers discussed below. In such embodiments, the nonwoven layer 16 may comprise a basis weight of at least 40, 45, 50, 55, 60, 65, or 70 gsm and/or less than 200, 175, 150, 140, 130, or 120 gsm as measured according to ASTM D461.

It should be noted that the nanofiber layer 12, the pre-filter layer 14, and the nonwoven layer 16 may be assembled together using either a thermal bond, an adhesive bond, and/or a sonic bond. Alternatively, in various embodiments, the nanofiber layer 12, the pre-filter layer 14, and the nonwoven layer 16 may be simply co-layered on each other.

Ideally, in various embodiments, the filter media 10, particularly the nanofiber layer 12, the pre-filter layer 14, and the nonwoven layer 16, will not contain any glass fibers. For instance, the nanofiber layer 12, the pre-filter layer 14, and the nonwoven layer 16 may each comprise less than 10, 5, 4, 3, 2, or 1 weight percent of glass fibers.

In order to further render the filter media 10 more resistant to water and thereby allow for optimum regeneration after washing, the nanofiber layer 12, the pre-filter layer 14, and/or the nonwoven layer 16 may be subjected to a durable water repellant (DWR) treatment. This can be done via a traditional impregnation bath/padder process, a monomer deposition, and/or a plasma vacuum process.

The durable water repellant may reduce the surface tension throughout all three layers of the filter media 10, thereby rendering the media both super hydrophobic and oleophobic. For instance, the untreated filter media could have an oil rating based upon AATCC-118 of 1 or 2, but after treatment with a durable water repellant, it could exhibit an oil rating of 7 or 8. Furthermore, the untreated filter media could have a water repellency rating according to AATCC-193 of 1 or 2; however, the water-repellant treated filter media may exhibit a water repellency rating of 10.

In various embodiments, the nanofiber layer 12, the pre-filter layer 14, and/or the nonwoven layer 16 can be subjected to a durable water repellant (DWR) treatment and thereby form a filter media that exhibits an oil rating of at least 4, 5, 6, 7, or 8 as measured according to AATCC-118. Additionally or alternatively, in various embodiments, the nanofiber layer 12, the pre-filter layer 14, and/or the nonwoven layer 16 can be subjected to a durable water repellant (DWR) treatment and thereby form a filter media that exhibits a water repellency of at least 4, 5, 6, 7, 8, 9, or 10 as measured according to AATCC-193.

The increased water and oil repellency enacted by the DWR treatment should allow for enhanced cleanability or washability of the final filter media and its ability to retain a lower operating pressure drop. Furthermore, the treated filter media could permit a reduced drying time after washes as the media will not “wet out” during the washing process. Additionally, the DWR treatment could also assist with cleaning off any hydrocarbon-based materials present in the environment, which can negatively impact the performance of many nonwoven filter media, such as micro-glass or meltblown media.

It should be noted that neither of the current HVAC media technologies, such as micro-glass or meltblown media, can effectively be treated with DWR without functionality being compromised. More particularly, the glass fiber media will be exposed to increased pressure drop or low air flow after the DWR treatment is applied. In addition, meltblown filter media cannot be exposed to moisture without the electrostatic charge being impacted.

In various embodiments, the filter media 10 may comprise a total basis weight of at least 35, 40, 45, 50, 55, 60, 65, 70, 75, 80, 85, 90, or 95 gsm and/or less than 200, 175, 150, 140, 130, 120, 115, or 110 gsm as measured according to ASTM D461. Additionally or alternatively, in various embodiments, the filter media 10 may comprise a thickness of at least 0.5, 1, 1.5, or 2 mm and/or less than 20, 15, 10, 5, 4, or 3 mm as measured according to TAPPI 411.

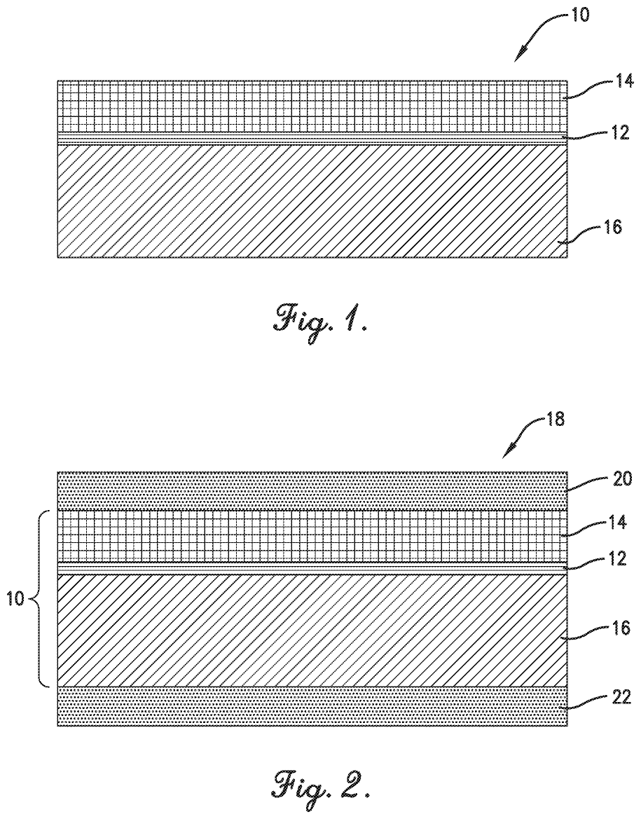

Turning now to FIG. 2, this depicts the filter media 10 comprising a pre-filter layer 14; a nonwoven layer 16; a nanofiber layer 12; a first pleating support layer 20; and a second pleating support layer 22. Generally, in various embodiments, the first pleating support layer 20 and the second pleating support layer 22 can comprise a metal mesh and/or a synthetic mesh, such as a polypropylene mesh or nylon mesh. The metal mesh can comprise a stainless steel or galvanized steel that is capable of resisting multiple washings.

Rather than relying on a nonwoven layer 16 with a heavier basis weight as discussed above, FIG. 2 depicts an alternative embodiment wherein the filter media comprises a first pleating support layer 20 and a second pleating support layer 22 to help form pleats in the resulting filter and provide durability to the media.

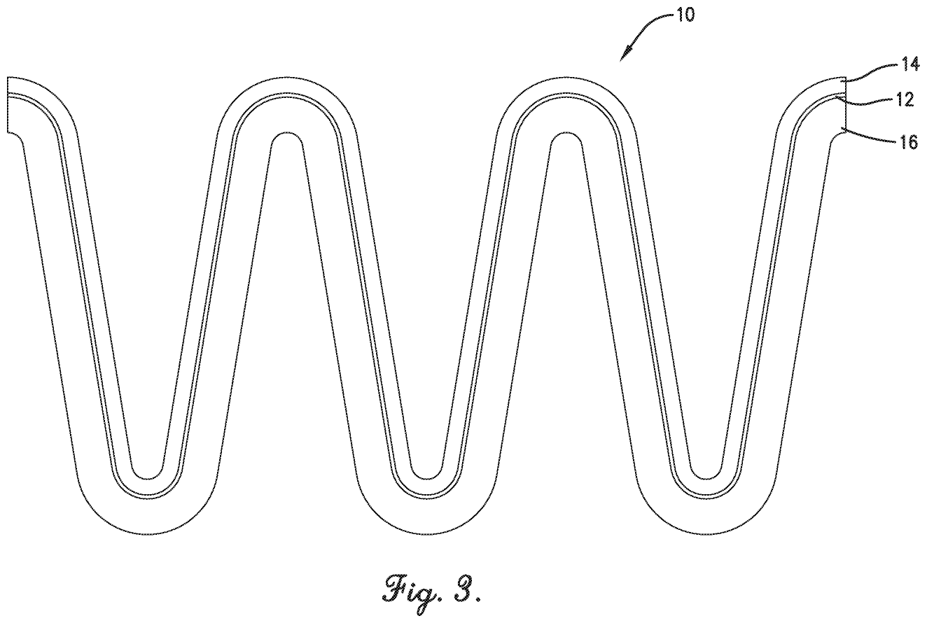

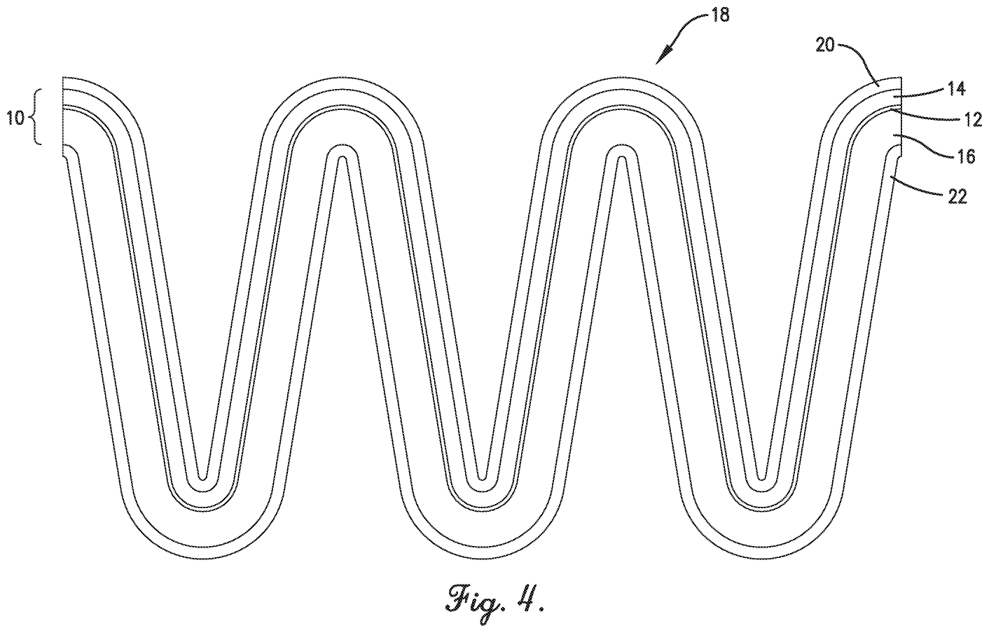

FIG. 3 depicts a pleated form of the filter media 10 from FIG. 1, while FIG. 4 depicts a pleated form of the filter media 10 from FIG. 4. Thus, there are embodiments wherein the filter media can be pleated in a stand-alone form (without a first pleating support layer 20 and a second pleating support layer 22) or co-pleated with a first pleating support layer 20 and/or a second pleating support layer 22.

Thus, as shown in FIGS. 3 and 4, the filter media 10 may comprise a plurality of pleats. The size and number of the pleats may be varied depending on the desired filtration efficiency. In various embodiments, the filter media comprises pleats having an average height, as measured from the trough of the pleat to the crest of the pleat, of at least 0.5, 0.75, 1, 1.5, 2, 2.5, 3, 3.5, 4, 4.5, or 5 cm and/or less than 25, 20, or 15 cm.

In certain embodiments, the inventive filter media 10 can comprise a pleated filter media comprising: (a) a nanofiber layer 12 exhibiting a filtration efficiency of at least MERV 9, MERV 10, MERV 11, MERV 12, MERV 13, MERV 14, MERV 15, MERV 16, or MERV 17 as measured according to the ASHRAE 52.2 standard; (b) a pre-filter layer 14 having a basis weight of 20 to 40 gsm; (c) a nonwoven layer 16 having a basis weight of 20 to 40 gsm; and (d) at least one pleating support layer on either one or both the pre-filter layer 14 and nonwoven layer 16.

In other embodiments, the inventive filter media 10 can comprise a pleated filter media comprising: (a) a nanofiber layer 12 exhibiting a filtration efficiency of at least MERV 9, MERV 10, MERV 11, MERV 12, MERV 13, MERV 14, MERV 15, MERV 16, or MERV 17 as measured according to the ASHRAE 52.2 standard; (b) a pre-filter layer 14 having a basis weight of 20 to 40 gsm; and (c) a nonwoven layer 16 having a basis weight of 70 to 120 gsm. In such embodiments, the filter media may not require the use of a pleating support layer for support and stability.

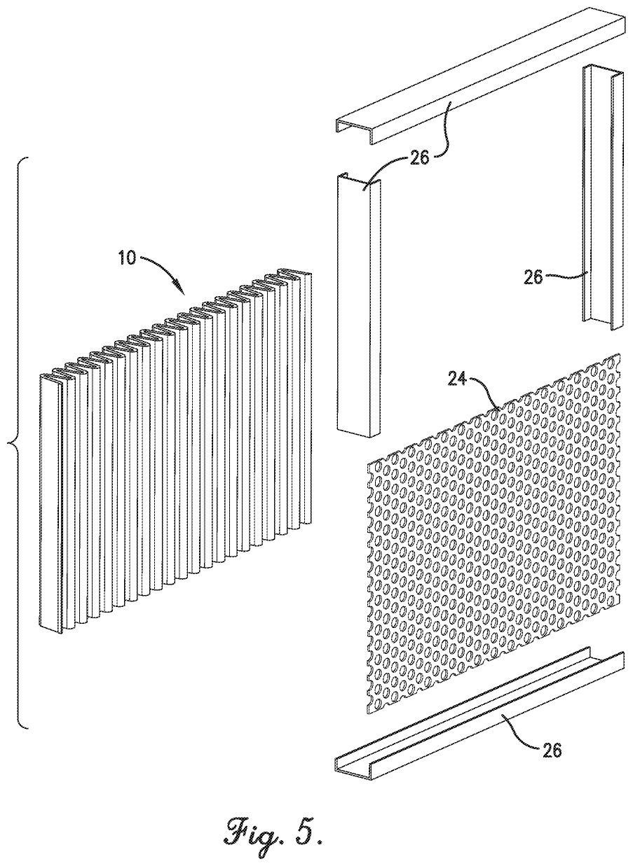

As shown in FIG. 5, a filter cartridge can be assembled with the filter media 10 comprising at least one support layer 24, which may be held in position by a water-resistant frame 26. The support layers 24 can correspond to the first pleating support layer 20 and/or the second pleating support layer 22 and, therefore, may comprise a metal mesh and/or synthetic mesh, such as a polypropylene mesh or nylon mesh. In such embodiments, the first pleating support layer 20 and/or the second pleating support layer 22 can be in the form of flat perforated sheets. The frame 26 may be formed from a water-resistance plastic or metal capable of withstanding multiple washes. For instance, the frame 26 may be produced from an extruded urethane plastic or an injection molded plastic. The filter assembly may be assembled by using sealing glues or adhesives along the edges of the filter media 10 and support layer 26.

Due to the configurations described above, the filter media of the present invention can be washable and maintain its filtration efficiency and performance over multiple wash and use cycles.

In various embodiments, the filter media of the present invention can exhibit an initial (pre-wash) filtration efficiency of at least MERV 9, MERV 10, MERV 11, MERV 12, MERV 13, or MERV 14 and/or less than MERV 19, MERV 18, or MERV 17 as measured according to the ASHRAE 52.2 standard. The MERV rating dictates how much dust the filter will hold when it reaches maximum pressure drop.

Furthermore, in various embodiments, the filter media of the present invention can exhibit a post-wash filtration efficiency of at least MERV 9, MERV 10, MERV 11, MERV 12, MERV 13, or MERV 14 and/or less than MERV 19, MERV 18, or MERV 17 as measured according to the ASHRAE 52.2 standard after 1, 2, 3, 4, or 5 wash cycles.

In various embodiments, the filter media of the present invention can exhibit an initial filtration efficiency of at least 90, 91, 92, 93, 94, 95, 96, 97, 98, or 99 percent of particles having a size range of 3 to 10 microns as measured according to the ASHRAE 52.2 test method. Furthermore, in various embodiments, the filter media of the present invention can exhibit a post-wash filtration efficiency of at least 90, 91, 92, 93, 94, 95, or 96 percent of particles having a size range of 3 to 10 microns as measured according to the ASHRAE 52.2 test method after 1, 2, 3, 4, or 5 wash cycles. Generally, in various embodiments, the filter media exhibits a post-wash filtration efficiency that is not more than 45, 40, 35, 30, 25, 20, 15, or 10 percent lower than the initial filtration efficiency of the filter media after 1, 2, 3, 4, or 5 wash cycles. Moreover, in various embodiments, the filter media may maintain its filtration efficiency even after multiple washes. For example, after the first wash cycle, the filter media may still exhibit a secondary post-wash filtration efficiency that is not more than 45, 40, 35, 30, 25, 20, 15, 10, or 5 percent lower than the filtration efficiency after the first wash cycle.

As used herein, a single “wash cycle” involves the following steps: (i) removing the dirty filter media from the duct; (ii) spraying the dirty filter media at room temperature (˜23° C.) with an aqueous solution comprising a 3 percent solution of dishwashing detergent (Dawn® by Procter & Gamble) and tap water; (iii) rinsing the filter media at room temperature (˜23° C.) with additional tap water so as to remove substantially all of the soap and dirt therein; (iv) drying the washed filter at room temperature (˜23° C.) until the filter media reaches the initial filter media weight or the drying has completely ceased. As used herein, the “initial filter media weight” refers to the initial weight of the virgin filter media prior to any filtration use.

In various embodiments, the filter media of the present invention can exhibit superior air filtration performance and may be used for EPA and HEPA filtration. For example, the composite filtration media can exhibit a filter efficiency from E-10 to H-12 as measured using EN1822-2009 and/or from PM1-70 to PM1-85 according to the ISO 16890 test method. Thus, the filter media of the present invention can present a superior alternative to conventional EPA and HEPA filtration media, such as wetlaid glass media and/or electrostatically charged meltblown nonwovens, which exhibit environmental challenges (e.g., glass fibers) and/or loss in filtration performance via moisture exposure (e.g., meltblown media).

In various embodiments, the filter media exhibits an air permeability of at least 5, 10, 15, 20, 25, 30, 35, 40, 45, 50, 55, 60, 65, or 70 and/or less than 400, 300, 200, 175, 150, 125, 110, or 100 cfm at 0.5 inches of water as measured according to ASTM D 737.

The use of the newest nanofiber technology allows for the production of filter media that can exhibit the highest particulate capture at the lowest pressure drop. Thus, the consumer can now benefit from having true mechanical filtration performance at the lowest resistance, which is an ideal product design. Thus, in various embodiments, the filter media may exhibit a target pressure drop of at least 20, 25, 30, or 36 and/or less than 80, 70, 60, 50, or 45 pascals at 16.5 cm/sec face velocity as measured according to TSI 3160.

Although the above disclosure primarily focuses on the use of the inventive filter media in HVAC applications, it is envisioned that the filter media may find application in other filtration applications, such as in protective masks, industrial filtration, and power generation, where filters are not generally capable of being washed and reused.

This invention can be further illustrated by the following examples of embodiments thereof, although it will be understood that these examples are included merely for the purposes of illustration and are not intended to limit the scope of the invention unless otherwise specifically indicated.

### EXAMPLES

### Example 1

The inventive filter media was produced and compared to an existing commercial filter (i.e., an electrostatically charged meltblown polypropylene media having a basis weight of 101.7 gsm). The inventive filter media comprised a three-layered configuration as shown in FIG. 1. More particularly, the inventive filter media comprised a nonwoven polypropylene spunbond substrate having a basis weight of 23.7 gsm, an electrospun nanofiber layer comprising polyvinylidene fluoride nanofibers and having a basis weight of 0.17 gsm, and an electrostatically charged polypropylene meltblown pre-filter layer having a basis weight of 78 gsm.

For this test, the initial and post-wash MERV ratings were measured and compared for the inventive filter media (“New Invention”) and the current commercial product (“Current Product”) according to the ASHRAE 52.2 standard. These tests were conducted at a test air flow rate of 5.3 cm/s, a temperature of 25.7° C., a relative humidity of 48.5%, a barometric pressure of 99.29 kPa, and with a challenge aerosol of aerosolized KCl. Both of the filter medias were subjected to a wash cycle after each round of efficiency testing. Thus, the filter medias were subjected to a first wash cycle after the initial MERV rating of each filter media was measured. After each wash cycle, the MERV rating of the filter medias were again measured. The filter medias went through a total of five separate wash cycles.

Each individual wash cycle involved the following steps: (i) removing the dirty filter media from the duct; (ii) spraying the dirty filter media at room temperature (˜23° C.) with an aqueous solution comprising a 3 percent solution of dishwashing detergent (Dawn® by Procter & Gamble) and tap water; (iii) rinsing the filter media at room temperature (˜23° C.) with additional tap water so as to remove substantially all of the soap and dirt therein; (iv) drying the washed filter at room temperature (˜23° C.) until the filter media reached the initial filter media weight or the drying has completely ceased.

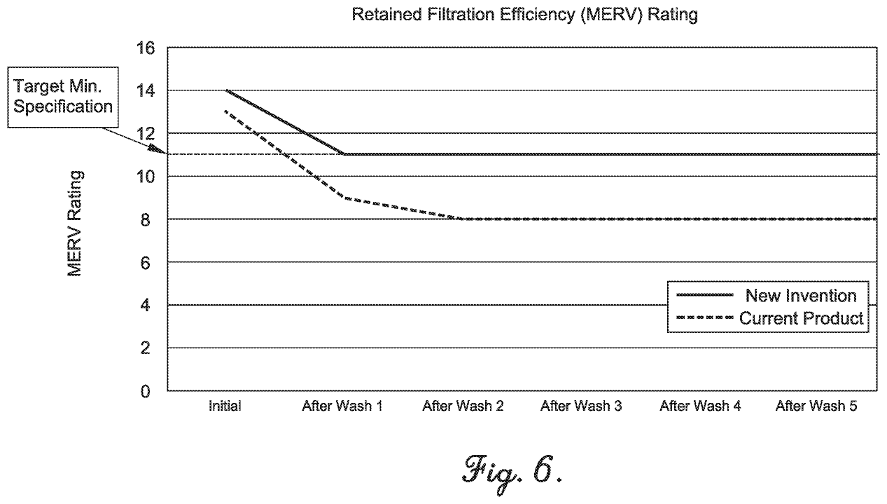

FIG. 6 is a chart demonstrating the filtration efficiencies of the inventive filter media and the comparative filter media after multiple washing cycles. More particularly, FIG. 6 demonstrates the change in MERV ratings for each filter media after multiple washings.

It is well known in the industry that any current MERV 11 filter using electrostatically charged meltblown filter media can attain greater than MERV 11 performance when new, but after a single wash, the filter efficiencies of such media can drop down to MERV 8 or less, as shown in FIG. 6. This is believed to be caused by the electrostatic charge being dissipated during the water washing process.

Unlike the current commercial filter media, and as shown in FIG. 6, the inventive filter media was able to retain a MERV rating of at least 11 after multiple washings. Thus, FIG. 6 demonstrates that not only does the inventive filter media exhibit the necessary filtration efficiencies for HVAC applications, but that the filter media can also be washed and reused for multiple uses.

### Example 2

A pleated inventive filter comprising the five-layered configuration of FIGS. 2 and 4 was produced and tested for filter efficiencies after multiple wash cycles using the protocol described in Example 1. More particularly, the inventive filter comprised a nonwoven polypropylene spunbond substrate having a basis weight of 23.7 gsm, an electrospun nanofiber layer comprising thermoplastic polyurethane nanofibers and having a basis weight of about 0.17 gsm, an electrostatically charged polypropylene meltblown pre-filter layer having a basis weight of 78 gsm, and two polypropylene meshes forming the outer surfaces of the pleated filter. The resulting filter was placed within a plastic frame and had dimensions of 14×20×1 inches. Additionally, the filter comprised 75 pleats.

As in Example 1, the initial MERV rating of the filter was measured according to the ASHRAE 52.2 standard. Afterwards, the filter was subjected to the wash cycles described in Example 1 and then the MERV rating was once again measured. The filter was subjected to five separate wash cycles and the MERV rating was measured after each cycle.

The filter exhibited an initial MERV rating of 11 and was able to retain a MERV rating of at least 11 after five wash cycles. Thus, this demonstrates that not only does the inventive filter exhibit the necessary filtration efficiencies for HVAC applications, but that the filter can also be washed and reused for multiple uses.

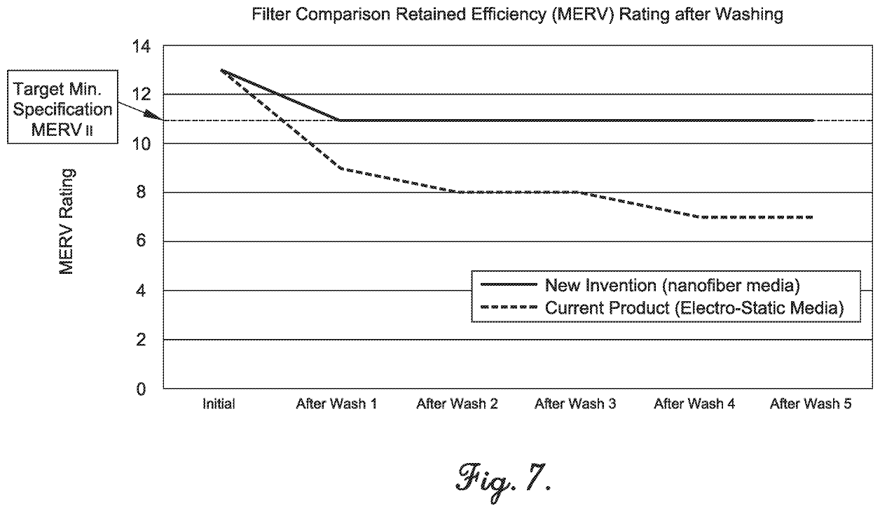

FIG. 7 is a chart comparing the filtration efficiencies of the inventive filter and a commercial filter (i.e., a filter comprising 100% electrostatically charged polypropylene meltblown filter media) after multiple washing cycles. More particularly, FIG. 7 demonstrates the change in MERV ratings for each filter after multiple washings.

Unlike the current commercial filter media, and as shown in FIG. 7, the inventive filter was able to retain a MERV rating of at least 11 after multiple washings. Thus, FIG. 7 demonstrates that not only does the inventive filter exhibit the necessary filtration efficiencies for HVAC applications, but that the filter can also be washed and reused for multiple uses.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A washable filter media, said filter media comprising:
(a) a pre-filter layer comprising one or more meltblown fibers;
(b) a nonwoven layer comprising one or more synthetic fibers; and
(c) a nanofiber layer comprising one or more nanofibers,
wherein said nanofiber layer is disposed between said pre-filter layer and said nonwoven layer,
wherein said filter media exhibits an initial filtration efficiency rating of at least MERV 11 as measured according to the ASHRAE 52.2 test method.

2. The washable filter media according to claim 1, wherein said filter media exhibits a post-wash filtration efficiency of at least MERV 11 as measured according to the ASHRAE 52.2 test method after one wash cycle.

3. The washable filter media according to claim 1, wherein said nanofibers comprise electrospun nanofibers.

4. The washable filter media according to claim 3, wherein said pre-filter layer is electrostatically charged.

5. The washable filter media according to claim 4, wherein said meltblown fibers comprise polyester fibers, polypropylene fibers, or combinations thereof.

6. The washable filter media according to claim 5, wherein said synthetic fibers comprise polyester fibers, polypropylene fibers, or combinations thereof.

7. The washable filter media according to claim 4, wherein said nanofibers comprise thermoplastic polyurethane fibers, polyvinylidene fluoride fibers, polyethersulfone fibers, or polyacrylonitrile fibers.

8. The washable filter media according to claim 1, wherein said pre-filter layer, said nanofiber layer, and said nonwoven layer have been treated with a durable water repellant, wherein said filter media exhibits a water repellency of at least 4 as measured according to AATCC-193.

9. A washable filter, said filter comprising:
(a) a pre-filter layer comprising one or more meltblown fibers;
(b) a nonwoven layer comprising one or more synthetic fibers;
(c) a nanofiber layer comprising one or more nanofibers, wherein said nanofiber layer is disposed between said pre-filter layer and said nonwoven layer;
(d) a first pleating support layer positioned proximately to said nonwoven layer; and
(e) a second pleating support layer positioned proximately to said pre-filter layer;
wherein said filter exhibits an initial filtration efficiency rating of at least MERV 11 as measured according to the ASHRAE 52.2 test method.

10. The washable filter according to claim 9, wherein said filter exhibits a post-wash filtration efficiency of at least MERV 11 as measured according to the ASHRAE 52.2 test method after one wash cycle.

11. The washable filter according to claim 9, wherein said nanofibers comprise electrospun nanofibers.

12. The washable filter according to claim 11, wherein said pre-filter layer is electrostatically charged.

13. The washable filter according to claim 11, wherein said meltblown fibers comprise polyester fibers, polypropylene fibers, or combinations thereof, wherein said synthetic fibers comprise polyester fibers, polypropylene fibers, or combinations thereof.

14. The washable filter according to claim 11, wherein said nanofibers comprise thermoplastic polyurethane fibers, polyvinylidene fluoride fibers, polyethersulfone fibers, or polyacrylonitrile fibers.

15. The washable filter according to claim 9, wherein said pre-filter layer, said nanofiber layer, and said nonwoven layer have been treated with a durable water repellant, wherein said filter exhibits a water repellency of at least 4 as measured according to AATCC-193.

16. A method of filtering a fluid stream, said method comprising:
(a) providing a filter media comprising—
(i) a pre-filter layer comprising one or more meltblown fibers;
(ii) a nonwoven layer comprising one or more synthetic fibers; and
(ii) a nanofiber layer comprising one or more nanofibers,
wherein said nanofiber layer is disposed between said pre-filter layer and said nonwoven layer,
wherein said filter media exhibits an initial filtration efficiency rating of at least MERV 11 as measured according to the ASHRAE 52.2 test method; and
(b) passing said fluid stream through said filter media.

17. The method according to claim 16, wherein said filter media exhibits a post-wash filtration efficiency of at least MERV 11 as measured according to the ASHRAE 52.2 test method after one wash cycle.

18. The method according to claim 16, wherein said nanofibers comprise electrospun nanofibers.

19. The method according to claim 16, wherein said meltblown fibers comprise polyester fibers, polypropylene fibers, or combinations thereof, wherein said synthetic fibers comprise polyester fibers, polypropylene fibers, or combinations thereof, and wherein said nanofibers comprise thermoplastic polyurethane fibers, polyvinylidene fluoride fibers, polyethersulfone fibers, or polyacrylonitrile fibers.

20. The method according to claim 16, wherein said pre-filter layer, said nanofiber layer, and said nonwoven layer have been treated with a durable water repellant, wherein said filter exhibits a water repellency of at least 4 as measured according to AATCC-193.
